(19) United States
(12) Patent Application Publication
(10) Pub. No.: US 2026/0081090 A1
(43) Pub. Date: Mar. 19, 2026

(54) MULTI-DIRECTIONAL CONNECTION HUB AND COLD CATHODE X-RAY TUBE THAT CAN EASILY CHANGE ITS CHARACTERISTICS AND ITS CONNECTION METHOD

(71) Applicant: ELECTRONICS AND TELECOMMUNICATIONS RESEARCH INSTITUTE, Daejeon (KR)

(72) Inventor: Jin Woo JEONG, Daejeon (KR)

(21) Appl. No.: 19/004,692

(22) Filed: Dec. 30, 2024

(30) Foreign Application Priority Data
Sep. 19, 2024 (KR) 10-2024-0126960
Dec. 24, 2024 (KR) 10-2024-0195979

(51) Int. Cl. H01J 35/06

(52) U.S. Cl. CPC H01J 35/064; H01J 2235/062; H01J 2235/18

(57) ABSTRACT

The present invention provides a multi-directional connection hub including a plurality of openings to which an anode adapter made of a metal material is connected through an insulation tube and an electron gun which emits electrons to the anode adapter to generate X-rays is connected, wherein the openings include a plurality of side openings to which the electron gun is connected and an upper opening through which the X-rays generated by the electrons, which are provided from the electron gun through the side opening and collide with the anode adapter, are emitted, and an emission direction of the X-rays is changed toward another side opening of the plurality of side openings or the upper opening according to a type of the anode adapter and a type or installation location of the electron gun.

### CROSS-REFERENCE TO RELATED APPLICATIONS

The present application claims priority and the benefit of Korean Patent Application No. 10-2024-0126960, filed on Sep. 19, 2024 and Korean Patent Application No. 10-2024-0195979, filed on Dec. 24, 2024 in the Korean Intellectual Property Office, the entire disclosure of which is incorporated herein by reference.

### BACKGROUND

### 1. Field of the Invention

The present invention relates to a multi-directional connection hub to which a cathode tube is connected in various directions to control an emission direction of X-rays, a cold cathode X-ray tube whose characteristics are easily changed thereby and a connection method therebetween.

### 2. Description of Related Art

In general, free electrons, which are present on a metal surface, are emitted from the metal surface when they receive energy greater than a work function. The work function has a unique value for each metal. In addition, when a high electric field is applied, or light with certain energy or more is irradiated, a phenomenon in which electrons are emitted from a metal surface occurs, and there are the following differences depending on the supplied energy. Thermionic emission is a phenomenon in which electrons are thermally excited and emitted over a potential barrier (work function) of a solid surface when thermal energy is supplied thereto, and photoemission is a phenomenon in which photons and electrons of a metal surface collide with each other when light with sufficient energy is irradiated on the metal surface, so that the electrons are emitted over a potential barrier (work function) of the solid surface. Field emission is a phenomenon in which electrons tunnel through a potential barrier of a solid surface and are emitted when a high electric field is applied and is different from a phenomenon in which surface electrons receive thermal energy or photoenergy and are emitted over a surface potential barrier.

As the electric field increases and the work function decreases, an emission current increases, so when an electron emission source is designed, the applied electric field should be maximized and the work function should be minimized. In this case the electric field relates to structural characteristics, and the work function relates to the characteristics of a material. Metals, silicon semiconductors, or compounds such as LaB₆ and ThO₂ are used as electric field emission materials, and in this case, heat resistance, corrosion resistance, mechanical durability, temperature characteristics (temperature dependence of work function and the like), and ease of process for a tip structure in addition to electron emission characteristics should be considered. Since the work function is a unique value of the material itself, the work function can be improved by developing a material, and one of the materials proposed as materials of electron emission sources is a carbon nanotube.

A carbon nanotube is that a hexagonal mesh structure made of carbon atoms are arranged in a plane, which is rolled into a cylindrical shape. The carbon nanotube has a single wall carbon nanotube (SW-CNT) structure, a multi wall carbon nanotube (MW-CNT) structure, or a bundle type structure including the SW-CNT structure and the MW-CNT structure, and mechanical, electrical, chemical characteristics thereof are changed according to a shape and a structure thereof. In particular, the work function of a carbon nanotube is smaller than that of a metal material, the electron emission voltage (1 to 3 V/μm) of the carbon nanotube is tens of times smaller than the electron emission voltage of other metal tips (Mo tip, 50 to 100 V/μm), so the carbon nanotube is used as a cold cathode electron emission material.

The related art of the present invention is disclosed in Korean Patent Registration No. 10-0789592 (Dec. 27, 2007, SOFT X-RAY TUBE WITH FIELD EMISSION COLD CATHODE BY USING CARBON NANOTUBE).

### SUMMARY OF THE INVENTION

The X-ray tube according to the conventional technology has a problem that a direction in which X-rays are emitted cannot be changed in various ways.

Therefore, there is a need to improve this.

The present invention is directed to providing a multi-directional connection hub whose structure is easily changed and manufactured to have various characteristics according to the purpose of use by providing a structure in which main components of an X-ray tube are easily changed, so that X-rays may be emitted in various directions, and mass production thereof is possible, a cold cathode X-ray tube whose characteristics are easily changed thereby, and a connection method therebetween.

According to an aspect of the present invention, there is provided a multi-directional connection hub including a plurality of openings to which an anode adapter made of a metal material is connected through an insulation tube and an electron gun which emits electrons to the anode adapter to generate X-rays is connected, wherein the openings include a plurality of side openings to which the electron gun is connected and an upper opening through which the X-rays generated by the electrons, which are provided from the electron gun through the side opening and collide with the anode adapter, are emitted, and an emission direction of the X-ray is changed toward another side opening of the plurality of side openings or the upper opening according to a type of the anode adapter and a type or installation location of the electron gun.

According to another aspect of the present invention, there is provided a cold cathode X-ray tube whose characteristics are easily changed by a multi-directional connection hub, the cold cathode X-ray tube including a hub including a plurality of openings, an insulation tube connected to the hub and made of a ceramic material, an anode adapter connected to the hub through the insulation tube and made of a metal material, and an electron gun which is installed in any one of the plurality of the openings and emits electrons to the anode adapter to generate X-rays, wherein the electron gun is installed in any one of the plurality of openings to control an emission direction of the X-rays emitted from the hub, and the emission direction of the X-rays emitted from the hub is changed by installing the electron gun or a plurality of electron guns according to a direction in which the anode adapter is installed.

The anode adapter of the present invention may include an anode part inserted into one side of the insulation tube and a collision surface which is provided on the anode part inserted into the insulation tube, with which the electrons provided from the electron gun collide to generate X-rays, and which determines the emission direction of the X-rays.

The anode part of the present invention may include a first anode in which the collision surface is formed as an inclined surface to change the emission direction of the X-rays generated by the electrons provided from the electron gun to a vertical direction and a second anode in which the collision surface is formed as a step to change the emission direction of the X-rays generated by the electrons provided from the electron gun to a horizontal direction.

The electron gun of the present invention may include a first electron gun including a first emitter suitable for low resolution characteristics including a relatively high tube current and a relatively large focal spot and a second electron gun including a second emitter suitable for high resolution characteristics including a low tube current and a small focal spot compared to the first emitter.

In the hub of the present invention, the first electron gun or the second electron gun may be selectively installed in any one of the plurality of openings to provide a low resolution X-ray tube or a high resolution X-ray tube.

In the hub of the present invention, the first electron gun may be installed in any one side opening of the plurality of side openings formed in side surfaces, and the second electron gun may be installed in another side opening of the plurality of side openings to provide low resolution characteristics and the high resolution characteristics to the insulation tube.

In the hub of the present invention, any one of the electron gun, an X-ray window, and a cap may be installed in the plurality of openings, and a vacuum pressure may be provided to an inner portion of the hub.

A metal film which maintains a vacuum and allows X-rays to be emitted may be formed in an upper opening formed in an upper surface of the hub of the present invention.

According to still another aspect of the present invention, there is provided a method of connecting a cold cathode X-ray tube whose characteristics are easily changed by a multi-directional connection hub, wherein the method is performed by a cold cathode X-ray tube whose characteristics are easily changed by a multi-directional connection hub and includes a hub including a plurality of openings, an insulation tube connected to the hub and made of a ceramic material, an anode adapter connected to the hub through the insulation tube and made of a metal material, and an electron gun which is installed in any one of the plurality of openings and emits electrons to the anode adapter to generate X-rays, wherein the electron gun is installed in any one of the plurality of openings to control an emission direction of the X-rays emitted from the hub, and the electron gun or a plurality of electron guns are installed according to a direction in which the anode adapter is installed to change the emission direction of the X-rays emitted from the hub.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a perspective view illustrating a cold cathode X-ray tube with easy-to-change characteristics according to one embodiment of the present invention;

FIG. 2 is a perspective view illustrating an anode tube of the cold cathode X-ray tube with easy-to-change characteristics according to one embodiment of the present invention;

FIG. 3 is a perspective view illustrating an electron gun constituting a cathode tube of the cold cathode X-ray tube with easy-to-change characteristics according to one embodiment of the present invention;

FIG. 4 is a configuration diagram illustrating a first use state of the cold cathode X-ray tube with easy-to-change characteristics according to one embodiment of the present invention;

FIG. 5 is a configuration diagram illustrating a second use state of the cold cathode X-ray tube with easy-to-change characteristics according to one embodiment of the present invention;

FIG. 6 is a configuration diagram illustrating a third use state of the cold cathode X-ray tube with easy-to-change characteristics according to one embodiment of the present invention; and

FIG. 7 is a cross-sectional view illustrating a hub of the cold cathode X-ray tube with easy-to-change characteristics according to one embodiment of the present invention.

### DETAILED DESCRIPTION OF EXEMPLARY EMBODIMENTS

Hereinafter, one embodiment of a cold cathode X-ray tube with easy-to-change characteristics according to the present invention will be described.

Sizes of components or thicknesses of lines in the drawings may be exaggerated for clarity and convenience of description.

In addition, some terms described below are defined in consideration of functions in the present invention, and meanings may vary depending on a user or operator's intentions or customs.

Therefore, the meanings of the terms should be interpreted based on the content throughout this specification.

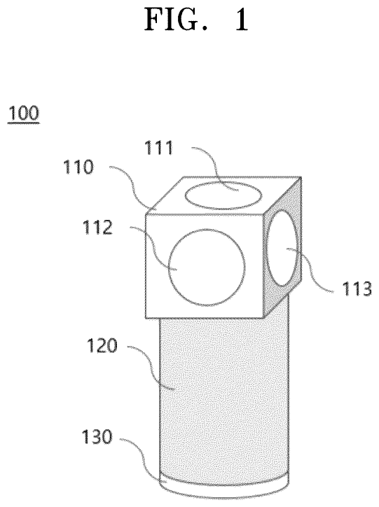

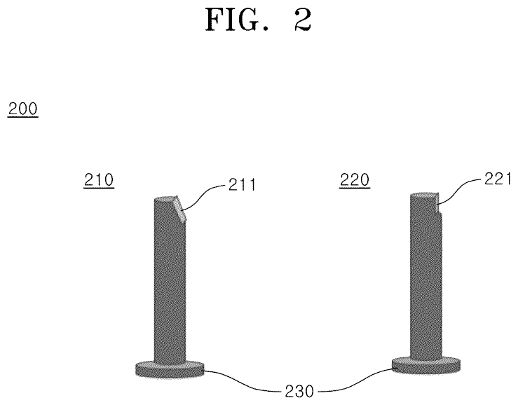

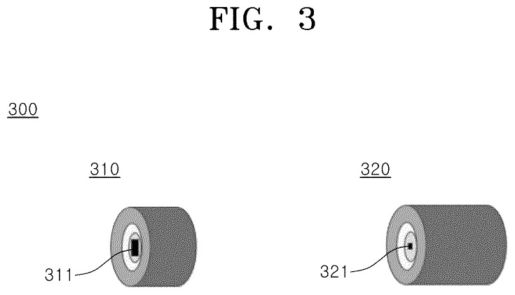

FIG. 1 is a perspective view illustrating a cold cathode X-ray tube with easy-to-change characteristics according to one embodiment of the present invention, FIG. 2 is a perspective view illustrating an anode tube of the cold cathode X-ray tube with easy-to-change characteristics according to one embodiment of the present invention, and FIG. 3 is a perspective view illustrating an electron gun constituting a cathode tube of the cold cathode X-ray tube with easy-to-change characteristics according to one embodiment of the present invention.

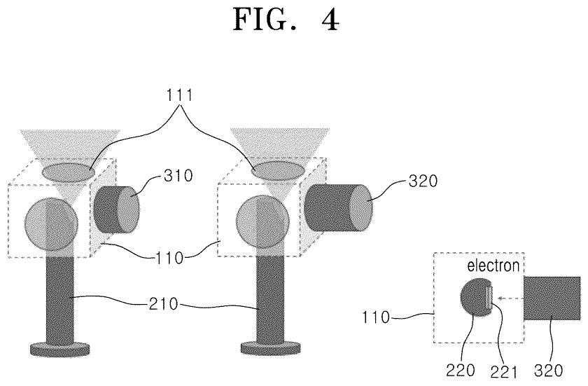

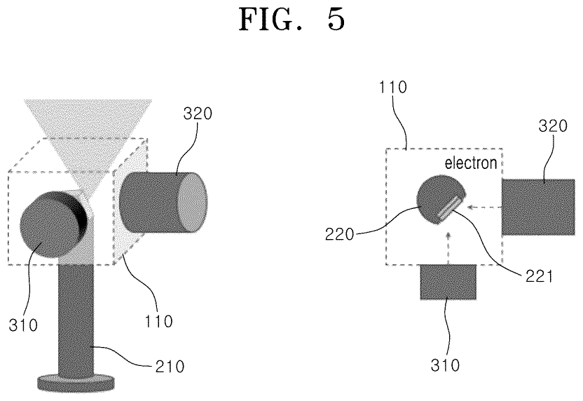

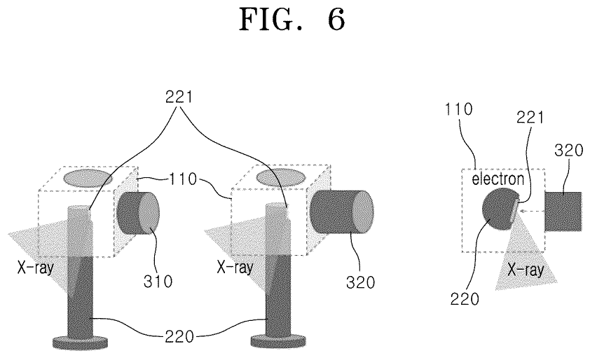

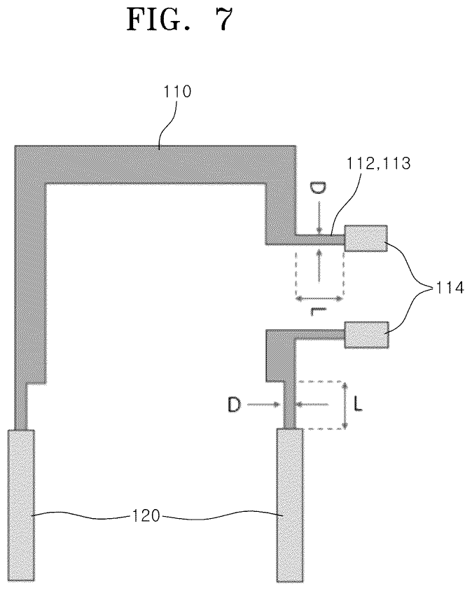

In addition, FIG. 4 is a configuration diagram illustrating a first use state of the cold cathode X-ray tube with easy-to-change characteristics according to one embodiment of the present invention, and FIG. 5 is a configuration diagram illustrating a second use state of the cold cathode X-ray tube with easy-to-change characteristics according to one embodiment of the present invention. FIG. 6 is a configuration diagram illustrating a third use state of the cold cathode X-ray tube with easy-to-change characteristics according to one embodiment of the present invention, and FIG. 7 is a cross-sectional view illustrating a hub of the cold cathode X-ray tube with easy-to-change characteristics according to one embodiment of the present invention.

Referring to FIGS. 1 to 7, in the cold cathode X-ray tube with easy-to-change characteristics according to one embodiment of the present invention, in the case of a general reflective anode X-ray tube using Bremsstrahlung generated when electrons emitted from a cathode are attracted by and collide with an anode having a relatively high electric potential, the anode having a relatively high voltage compared to the cathode generally has a tube structure for high-voltage insulation, and when the cathode from which the electrons are emitted and the anode are disposed at an end of the tube in a longitudinal direction, X-rays generated by an electron beam traveling in the longitudinal direction are emitted through a side of the tube.

However, when the cathode is disposed on the side of the tube, X-rays emitted outward from the insulation tube may be emitted in the longitudinal direction of the tube, and an X-ray emission direction may be selected by changing a structure according to the purpose of use of the X-ray tube.

In addition, in the X-ray tube, the cathode and the anode made of metal are coupled to an insulator such as glass or ceramic for high-voltage insulation between the cathode and the anode. In this case, since the insulator and the metal have different thermal expansion coefficients, structural stability can be weak due to stress after coupling, and thus a specific metal with a thermal expansion coefficient that matches glass or ceramic, such as Kovar, is used.

According to a cold cathode X-ray tube 100 with easy-to-change characteristics according to one embodiment of the present invention, X-ray tubes having different characteristics may be easily manufactured by joining one or more anode parts 200 having different shapes and electron guns 300 constituting cathodes to an insulation tube 120.

The X-ray tube 100 of the present embodiment may include a hub 110 made of a metal material, an insulation tube 120 made of a ceramic material, and an anode adapter 130 made of a metal material, the hub 110, the insulation tube 120, and the anode adapter 130 may be joined to form the X-ray tube 100 using a brazing method or the like, and a joining order thereof may be changed according to a combination of the anode parts 200 and the electron guns 300.

In the hub 110 according to the present embodiment, since three openings 111, 112, and 113 are formed as illustrated in FIG. 1, the electron guns, an X-ray window, and the like may be selectively joined or coupled to the three openings 111, 112, and 113 as needed, and when it is not needed, a plate serving as a cap may be joined to an opening to block the opening.

In addition, the number and locations of the openings provided in the hub 110 may be decreased, increased, or changed as needed, and the insulation tube 120 has a tube structure that is able to secure a predetermined insulation distance between the hub 110 and the anode adapter 130.

The anode adapter 130 of the present embodiment may allow the anode parts 200 and the insulation tube 120 made of different materials to be easily combined and may be omitted depending on a material and a structure.

The anode adapter 130 of the present embodiment includes one or more anode parts 200 inserted into one side of the insulation tube 120 and a collision surface which is provided in the anode parts 200 inserted into the insulation tube 120, with which electrons provided from the electron guns 300 collide to generate X-rays, and which determines an emission direction of the X-rays.

In addition, each of the anode parts 200 of the present embodiment includes a first anode part 210 which has a collision surface formed as an inclined surface 211 and adjusts the emission direction of the X-rays generated by the electrons provided from the electron guns 300 to a vertical direction and a second anode part 220 which has a collision surface formed as a step 221 and adjusts the emission direction of the X-rays generated by the electrons provided from the electron guns 300 to a horizontal direction.

As in FIG. 4, the anode part 200, which may be coupled to the X-ray tube 100, may include the inclined surface 211 in which a target with which an electron beam collides to generate X-rays is inclined at a predetermined angle with respect to a longitudinal direction of the anode part 200 and the step 220 which generates X-rays in the horizontal direction of the anode part.

In this case, a material, a diameter, a length, and a target angle of the anode part 200 may be changed as needed. For example, the material, the diameter, and the length of the anode part 200 may be changed according to an output of the X-ray tube 100, and when a high output is required, the diameter may increase, and the target angle may be changed and applied according to an emission angle of the X-rays and a size of the focal spot.

In addition, a lower anode part 230 coupled to the anode adapter 130 may have a circular structure so as to be rotated and coupled at a predetermined angle as needed.

The electron guns 300 which may be coupled to the X-ray tube 100 may be selected from the electron guns 300 having different emitters 311 and 321 as in FIG. 3, and include a first electron gun 310 including a first emitter 311 with a large size suitable for low resolution characteristics (a high tube current and a large focal spot), and a second electron gun 320 including a second emitter 321 with a small size suitable for high resolution characteristics (a low tube current and a small focal spot) Referring to FIG. 5, in the hub 110 of the X-ray tube 100, different electron guns 300 may be joined to the side opening 113, thereby manufacturing low resolution (high output power) and high resolution (low output power) X-ray tubes using the same anode part 220.

In this case, a thin metal film (a thin copper film with a thickness of 0.05 mm or less) may be bonded to an upper opening 111 of the hub 110 to allow X-rays to be emitted while maintaining a vacuum, and since a side opening 112 is not needed, a dummy metal plate may be joined thereto, or the side opening 112 may not be formed during processing to maintain a vacuum.

Referring to FIG. 8, when the different electron guns 300 are joined simultaneously to the side openings 112 and 113 of the hub 110 of the present embodiment, one tube may have both low resolution (high output power) and high resolution (low output power) characteristics, and in this case, the anode part 200 is joined by being rotated 45° to face two electron guns 300 equally.

In the present invention illustrated in FIGS. 1 to 5, the first anode part 210 including the inclined surface 211 is applied, so that X-rays are emitted in the longitudinal direction of the tube, and when the second anode part 221 including the step 221, which is the target, disposed to be parallel to the longitudinal direction of the anode part 200 is applied as in FIG. 5, a structure in which X-rays are emitted through the side of the tube may be manufactured. In addition, similarly, the electron gun 300 may be selected and coupled to correspond to the characteristics of the tube, and the anode part 200 may be rotated and joined at a predetermined angle to control an emission angle of the emitted X-rays. In addition, the upper opening of the hub 110 may be blocked by a dummy plate, or may be omitted when the hub 110 is manufactured.

Since the hub 110 of the present embodiment has a compatible structure which may be applied to tubes with different characteristics, the hub 110 should be mass-produced at a low price, but an expensive alloy material such as Kovar is generally used to facilitate joining to the insulation tube made of a ceramic material. As illustrated in FIG. 7, when there is a joint structure of the hub 110 and the insulator and the hub 110 and the electron gun 300, brazing joints are possible with inexpensive stainless steel (SUS-304) materials.

In general, a metal may be used for an electrode, an insulator such as a ceramic may be used for the insulation tube 120, and the two materials may be joined by brazing. When two materials with different thermal expansion coefficients are physically joined, stress is generated, and when the stress is greater than the structural strength, cracks occur.

Accordingly, a structure capable of structurally absorbing deformation even when the stress is generated is required. As illustrated in FIG. 7, a joint portion joined to the ceramic insulator may be formed in a thin tube shape to induce deformation so as to prevent cracks even when stress is generated.

A length L and a thickness D of the tube-shaped joint portion may be determined according to diameters D and d. In the case of alumina and SUS-304 materials, a value of the length L should be in the range of 5 to 10 times the thickness D. The joint portion may be processed as one body with the hub, and may be joined after processing with the same material.

Accordingly, as a structure in which the main components of the X-ray tube are easily changed is provided, the structure may be easily changed and manufactured to have various characteristics according to the purpose of use, thereby providing a cold cathode X-ray tube that can emit X-rays in various directions, can be mass-produced, and has easy-to-change characteristics.

Although the present invention has been described with reference to the embodiments illustrated in the accompanying drawings, these are merely exemplary. It will be understood by those skilled in the art that various modifications and other equivalent embodiments are possible from the embodiments of the present invention.

In addition, although an example of the cold cathode X-ray tube with easy-to-change characteristics has been described, this is merely exemplary and the cold cathode X-ray tube of the present invention may be used for other products other than the cold cathode X-ray tube with easy-to-change characteristics.

A multi-directional connection hub and a cold cathode X-ray tube whose characteristics are easily changed thereby and a connection method therebetween according to the present invention have an advantage that, as an anode tube and a cathode tube are connected to an insulation tube, X-rays generated when electrons emitted from the cathode tube collide with the anode tube are emitted outward from the insulation tube, thereby enabling the X-rays to be used for various purposes.

In addition, a multi-directional connection hub and a cold cathode X-ray tube whose characteristics are easily changed thereby and a connection method therebetween according to the present invention have an advantage that, since a hub which allows an anode tube and a cathode tube to be connected to an insulation tube in various directions is provided, the anode tube and the cathode tube are selectively coupled to a plurality of connection holes provided in the hub, so that an emission direction of X-rays generated by electron collisions can be controlled in various ways.

Therefore, the scope of the present invention should be defined by the appended claims.

What is claimed is:

1. A multi-directional connection hub comprising a plurality of openings to which an anode adapter made of a metal material is connected through an insulation tube and an electron gun which emits electrons to the anode adapter to generate X-rays is connected,
wherein the openings include a plurality of side openings to which the electron gun is connected and an upper opening through which the X-rays generated by the electrons, which are provided from the electron gun through the side opening and collide with the anode adapter, are emitted, and
an emission direction of the X-rays is changed toward another side opening of the plurality of side openings or the upper opening according to a type of the anode adapter and a type or installation location of the electron gun.

2. A cold cathode X-ray tube whose characteristics are easily changed by a multi-directional connection hub, the cold cathode X-ray tube comprising:
a hub including a plurality of openings;
an insulation tube connected to the hub and made of a ceramic material;
an anode adapter connected to the hub through the insulation tube and made of a metal material; and
an electron gun which is installed in any one of the plurality of the openings and emits electrons to the anode adapter to generate X-rays,
wherein the electron gun is installed in any one of the plurality of openings to control an emission direction of the X-rays emitted from the hub, and
the emission direction of the X-rays emitted from the hub is changed by installing the electron gun or a plurality of electron guns according to a direction in which the anode adapter is installed.

3. The cold cathode X-ray tube of claim 2, wherein the anode adapter includes:
an anode part inserted into one side of the insulation tube; and
a collision surface which is provided on the anode part inserted into the insulation tube, with which the electrons provided from the electron gun collide to generate the X rays, and which determines the emission direction of the X-rays.

4. The cold cathode X-ray tube of claim 3, wherein the anode part includes:
a first anode whose collision surface is formed as an inclined surface to change the emission direction of the X-rays generated by the electrons provided from the electron gun to a vertical direction; and
a second anode whose collision surface is formed as a step to change the emission direction of the X-rays generated by the electrons provided from the electron gun to a horizontal direction.

5. The cold cathode X-ray tube of claim 2, wherein the electron gun includes:
a first electron gun including a first emitter suitable for low resolution characteristics including a relatively high tube current and a relatively large focal spot; and
a second electron gun including a second emitter suitable for high resolution characteristics including a low tube current and a small focal spot compared to the first emitter.

6. The cold cathode X-ray tube of claim 5, wherein, in the hub, the first electron gun or the second electron gun is selectively installed in any one of the plurality of openings to provide a low resolution X-ray tube or a high resolution X-ray tube.

7. The cold cathode X-ray tube of claim 5, wherein, in the hub, the first electron gun is installed in any one side opening of a plurality of side openings formed in side surfaces, and the second electron gun is installed in another side opening of the plurality of side openings to provide low resolution characteristics and high resolution characteristics to the insulation tube.

8. The cold cathode X-ray tube of claim 2, wherein, in the hub:
any one of the electron gun, an X-ray window, and a cap is installed in the plurality of openings; and
a vacuum pressure is provided to an inner portion of the hub.

9. The cold cathode X-ray tube of claim 2, wherein a metal film which maintains a vacuum and allows X-rays to be emitted is formed in an upper opening formed in an upper surface of the hub.

10. A method of connecting a cold cathode X-ray tube whose characteristics are easily changed by a multi-directional connection hub,
wherein the method is performed by a cold cathode X-ray tube whose characteristics are easily changed by a multi-directional connection hub and includes:
a hub including a plurality of openings;
an insulation tube connected to the hub and made of a ceramic material;
an anode adapter connected to the hub through the insulation tube and made of a metal material; and
an electron gun which is installed in any one of the plurality of openings and emits electrons to the anode adapter to generate X-rays,
wherein the electron gun is installed in any one of the plurality of openings to control an emission direction of the X-rays emitted from the hub, and
the electron gun or a plurality of electron guns are installed according to a direction in which the anode adapter is installed to change the emission direction of the X-rays emitted from the hub.
